(19) United States
(12) Patent Application Publication
(10) Pub. No.: US 2018/0082002 A1
(43) Pub. Date: Mar. 22, 2018

(54) SYSTEMS AND METHODS FOR ONLINE MODEL VALIDATION

(71) Applicant: ExxonMobil Research and Engineering Company, Annandale, NJ (US)

(72) Inventors: Henry F. Demena, Naples, FL (US); Matthew G. Lee, Zachary, LA (US); Kenneth H. Tyner, The Woodlands, TX (US); Kathryn A. Stenberg, Houston, TX (US)

(21) Appl. No.: 15/696,688

(22) Filed: Sep. 6, 2017

Related U.S. Application Data
(60) Provisional application No. 62/396,497, filed on Sep. 19, 2016.

(51) Int. Cl. G06F 17/50; G06F 17/18

(52) U.S. Cl. CPC G06F 17/5009; G06F 2217/16; G06F 17/18

(57) ABSTRACT

The disclosed subject matter includes a method for validation of a predictive model. A predictive model can be provided. Plant data can be captured. The plant data can be stored and screened to determine whether the plant data has a data quality above a threshold. If the data quality of the plant data is above a threshold, it can be supplied to the predictive model. The predictive model can determine a predicted yield based on the plant data. The predicted yield can be compared to the plant data to determine if a deviation between the plant data and the predicted yield exceeds an acceptable error tolerance. If the deviation exceeds the acceptable error tolerance, an alert can be sent.

### CROSS-REFERENCE TO RELATED APPLICATIONS

This application claims priority to U.S. Provisional Application Ser. No. 62/396,497 filed Sep. 19, 2016, which is herein incorporated by reference in its entirety.

### BACKGROUND

### Field of the Disclosed Subject Matter

The present disclosed subject matter relates to validation of a predictive model, including an automated process for validating and adjusting a predictive model, for example, a predictive model for enhancing feedstock selection, production, planning, and operation of a plant or refinery.

### Description of Related Art

Predictive models can include individual representations of process units (sometimes called sub-models), each of which can be developed to reflect expected operation over a range of inputs. For example, the individual units of a plant predictive model can be developed to reflect predicted outputs such as unit yields or qualities over a range of inputs such as feed qualities and operating conditions.

The individual unit representations, which can be accurate at the time of initial development, can be continually evaluated to determine their accuracy against current operation, e.g., current plant operation. The processes to collect plant data, pre-process the data, run the sub-models and reference models, review results, recommend sub-model update requirements, and ultimately update the sub-models can be very time and resource intensive. For example, various manual and semi-automated procedures can be used to accomplish the aforementioned processes. The time and resource requirements of such procedures can result in the models being updated infrequently and thus being less accurate at predicting current operation.

As such, there remains a need for an automated process for validating a predictive model.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, a method for validation of a predictive model includes providing a predictive model and capturing plant data. The plant data can be stored and screened to determine whether the plant data has a data quality above a threshold. If the data quality of the plant data is above a threshold, the plant data can be supplied to the predictive model. The predictive model can determine a predicted yield based on the plant data. The predicted yield can be compared to the plant data to determine if a deviation between the plant data and the predicted yield exceeds an acceptable error tolerance. If the deviation exceeds the acceptable error tolerance, an alert can be sent.

For purpose of illustration and not limitation, the predictive model can be a non-linear process model. In some embodiments, the non-linear process model can include a plurality of unit representations.

In some exemplary embodiments, plant data can be captured by at least one of a control computer or a data historian. Additionally or alternatively, the plant data can be stored in a database. The plant data can include plant inputs and plant outputs. For example, the plant inputs can include at least one of feed properties or operating conditions. Additionally or alternatively, the plant outputs can include at least one of unit yields or qualities.

Furthermore, and as embodied herein, the plant data can be screened by reconciling the plant data based on a separate process model. Additionally or alternatively, data quality above a threshold can include one of data within a desired confidence limit, such as for example a 95% confidence limit or data within a desired standard deviation, such as for example twice the standard deviation from the average. These examples are considered to be nonlimiting. Other limits and deviations are considered to be well within the scope of the present invention. In this situation, the separate process model has an objective function which is generally a combination of the squared, scaled deviations between reconciled values and raw plant values but may also include additional terms. The process model then minimizes the objective function to reconcile or “screen” the data. If the objective function value is above some threshold (lower is better in this case), then the solution is rejected and we wait a certain time period to attempt the reconciliation again. If the objective function value is below the threshold, the data is provided to the predictive model to do the validation or to a validation module. Additionally or alternatively, data quality above a threshold can include data that satisfies solution quality controls when used in connection with the validation module. For example and not limitation, if the reconciliation fails to satisfy the solution quality controls, then the plant data can be determined to have insufficient data quality. Additionally, as embodied herein, if the data quality is not above the threshold, the plant data can be withheld from the predictive model. Alternatively, the plant data can be provided to the predictive model, and the plant data can be screened after the predicted yield is determined. Additionally or alternatively, the separate process model can provide missing input or output data. One additional feature is that the data screening module can be automated to run multiple times per day, which can then provide data at much higher frequency than prior art which would have relied on a combination of plant data and laboratory data.

Additionally, and as embodied herein, the plant inputs can be supplied to the predictive model. Additionally or alternatively, the predicted yield can include at least one of predicted unit yields or predicted qualities. The predicted yield can be compared to the plant outputs. For example, at least one of predicted unit yields or predicted qualities can be compared to at least one of unit yields or qualities from the plant data. Additionally or alternatively, the reconciled plant data can be compared to the various model design bases (DOE ranges, base model vector, reference model base case, etc.) to determine a deviation from one of Design-of-Experiment (DOE) validity ranges, predictive model base vector, reference model base case, or average plant data. Additionally or alternatively, after determining the predicted yield, the plant data can be screened again, as described herein. For example, the acceptable error tolerance can include one of a 95% confidence limit or twice the standard deviation from the average. Additionally or alternatively, acceptable error tolerance can include a percent deviation between the predicted yield and the plant outputs, for example, more than 20% different, and the percent deviation can be configurable. Additionally or alternatively, the acceptable error tolerance can include whether the average plant data is within the DOE ranges.

In some embodiments, comparing the predicted yield to the plant data further can include determining a suggested adjustment to the predictive model and a level of economic significance of the suggested adjustment. For purpose of illustration and not limitation, the suggested adjustment to the predictive model and the level of economic significance of the suggested adjustment can be determined based on a model sensitivity analysis. The model sensitivity analysis can include at least one of a model sensitivity matrix or a Monte Carlo analysis.

Additionally, and as embodied herein, the alert can include the suggested adjustment to the predictive model and the level of economic significance of the suggested adjustment. For purpose of illustration and not limitation, the suggested adjustment to the predictive model and the level of economic significance of the suggested adjustment can be based on a model sensitivity analysis. For example, the model sensitivity analysis can include at least one of a model sensitivity matrix or a Monte Carlo analysis.

In some embodiments, an instruction whether to update the predictive model can be received in response to the alert. Additionally or alternatively, if the instruction is to update the predictive model, the predictive model can be adjusted to reduce the deviation.

In accordance with another aspect of the disclosed subject matter, a system for validation of a predictive model can include one or more processors and one or more non-transitory computer readable storage media embodying software. The software can be configured when executed by one or more of the processors to provide a predictive model, capture plant data, store the plant data, screen the plant data to determine whether the plant data has a data quality above a threshold, supply the plant data to the predictive model if the data quality of the plant data is above a threshold, determine by the predictive model a predicted yield based on the plant data, compare the predicted yield to the plant data to determine if a deviation between the plant data and the predicted yield exceeds an acceptable error tolerance, and send an alert if the deviation exceeds the acceptable error tolerance.

In some embodiments, the software can be further configured to receive an instruction whether to update the predictive model in response to the alert. Additionally or alternatively, the software can be further configured to adjust the predictive model to reduce the deviation if the instruction is to update the predictive model.

In accordance with another aspect of the disclosed subject matter, a non-transitory computer readable medium can include a set of executable instructions to direct a processor to provide a predictive model, capture plant data, store the plant data, screen the plant data to determine whether the plant data has a data quality above a threshold, supply the plant data to the predictive model if the data quality of the plant data is above a threshold, determine by the predictive model a predicted yield based on the plant data, compare the predicted yield to the plant data to determine if a deviation between the plant data and the predicted yield exceeds an acceptable error tolerance, send an alert if the deviation exceeds the acceptable error tolerance.

In some embodiments, the set of executable instructions can further direct the processor to receive an instruction whether to update the predictive model in response to the alert. Additionally or alternatively, the set of executable instructions can further direct the processor to adjust the predictive model to reduce the deviation if the instruction is to update the predictive model.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a diagram illustrating a representative system according to an illustrative embodiment of the disclosed subject matter.

FIG. 2 is a flow chart illustrating a representative method implemented according to an illustrative embodiment of the disclosed subject matter.

FIGS. 3A, 3B, 3C, 3D, 3E, 3F, 3G, and 3H each is an exemplary image illustrating a representative graphical user interface for use with the system of FIG. 1 and/or the method of FIG. 2 according to an illustrative embodiment of the disclosed subject matter.

FIG. 4 is an exemplary diagram illustrating further details of a representative system according to an illustrative embodiment of the disclosed subject matter.

FIG. 5 is an exemplary diagram illustrating exemplary opportunity areas for Optimizable Refinery Models (ORMs) according to an illustrative embodiment of the disclosed subject matter.

FIG. 6 is an exemplary diagram illustrating a representative method to develop a derived model from a tuned reference model according to an illustrative embodiment of the disclosed subject matter.

### DETAILED DESCRIPTION OF THE PREFERRED EMBODIMENT

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The systems and methods presented herein can be used for automated validation of a predictive model. The disclosed subject matter is particularly suited for automated validation and adjustment of a predictive model, for example, a predictive model for enhancing feedstock selection, production, planning, and operation of a plant or refinery.

In accordance with the disclosed subject matter herein, a method for validation of a predictive model can include providing a predictive model. Data, for example plant or refinery data, can be captured. The data can be stored. The data can also be screened to determine whether the data has a data quality above a threshold. If the data quality of the plant data is sufficient, the data can be supplied to the predictive model. The predictive model can determine a predicted yield based on the data. The predicted yield can be compared to the data to determine if a deviation between the data and the predicted yield exceeds an acceptable error tolerance. If the deviation exceeds the acceptable error tolerance, an alert can be sent.

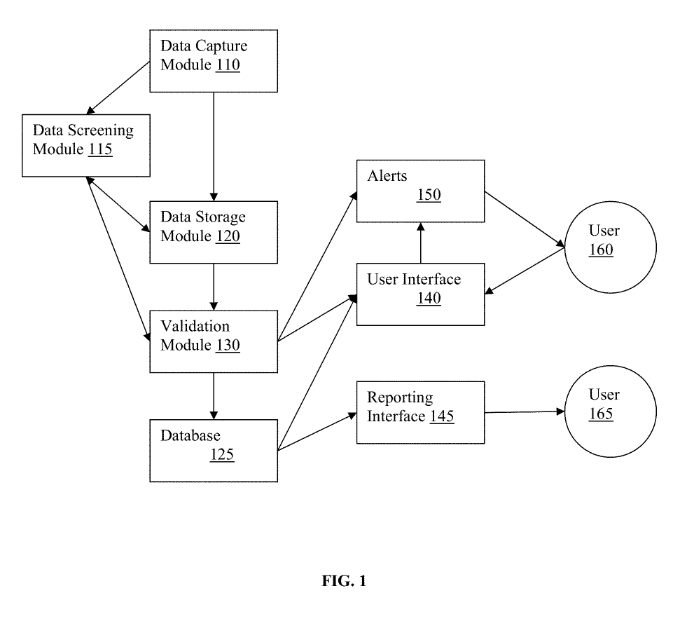

The accompanying figures, where like reference numerals refer to identical or functionally similar elements throughout the separate views, further illustrate various embodiments and explain various principles and advantages all in accordance with the disclosed subject matter. For purpose of explanation and illustration, and not limitation, exemplary embodiments of systems and methods for validation of a predictive model in accordance with the disclosed subject matter are shown in FIGS. 1-7. While the present disclosed subject matter is described with respect to using the systems and methods for validation of predictive models of a plant such as a refinery, one skilled in the art will recognize that the disclosed subject matter is not limited to the illustrative embodiment. For example, the systems and methods for validation of predictive models can be used with a wide variety of predictive models, such as predictive models for a lab, a manufacturing facility, a piece of equipment, or any other suitable predictive model.

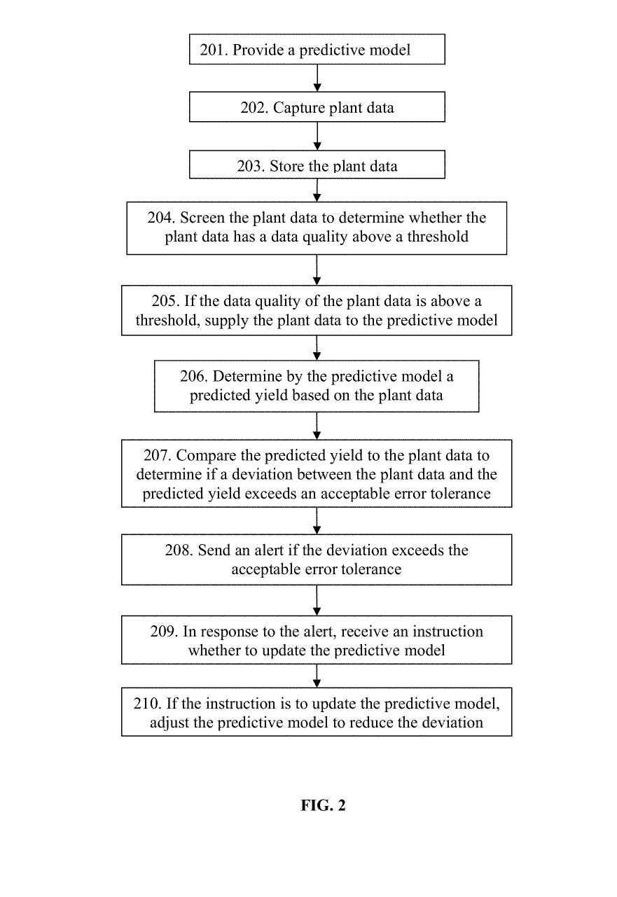

FIG. 1 is a diagram showing an exemplary system according to an illustrative embodiment of the disclosed subject matter. A system for validation of a predictive model can include one or more computer systems, as discussed further below. FIG. 2 is a flow chart illustrating a representative method implemented according to an illustrative embodiment of the disclosed subject matter. The exemplary system of FIG. 1, for purpose of illustration and not limitation, is discussed with reference to the exemplary method of FIG. 2. Referring to FIG. 2, at 201, a predictive model to be validated can be provided. The predictive model can be any kind of predictive model. For example and not limitation, as embodied herein, the predictive model can be a combination or integration of various sub-models, derived models, or process models. Sub-models, derived models, and/or process models can include, for purpose of illustration and not limitation, complex first-principles based phenomenological models, which can include but are not limited to molecular, property, hydrodynamic, economic, and/or performance models. Specific examples of predictive models as well as sub-models, derived models, and process models are discussed below. For purpose of illustration and not limitation, the predictive model can be a non-linear process model. In some embodiments, the non-linear process model can be a combination of a plurality of unit representations, where each unit representation can be a linear or non-linear model of a smaller process or unit.

At 202, data can be captured. For purpose of illustration and not limitation, an exemplary system can include a data capture module 110 to capture, for example and not limitation, plant or refinery data. For example, the data capture module 110 can be a control computer, a data historian, or any other suitable data capture component. As embodied herein, for example and not limitation, data can be continuously and automatically captured. Continuous data capture can, for example, provide higher data density than manual collection of data, as discussed herein. Additionally, continuous data capture and data screening can provide higher data density for predictive model validation than ad-hoc, manual, or semi-automated processes.

For purpose of illustration and not limitation, data such as plant or refinery data can be captured using flow instruments, temperature sensors, pressure sensors, or any other suitable component to measure and gather data. In some embodiments, the captured data can include raw data. Additionally or alternatively, the captured data can include model-reconciled data, for example, from a separate sub-model, process model, or derived model. The captured data can be electronically communicated to the data capture module 110 (e.g. a plant historian or control computer). Furthermore, the data can include inputs and outputs. For purpose of illustration and not limitation, in operation in a plant, the plant data can include plant inputs and plant outputs. For example, the plant inputs can include at least one of feed properties, operating conditions, or the like, as discussed below. Additionally or alternatively, the plant outputs can include at least one of unit yields, qualities, or the like, as discussed below.

Furthermore, and as embodied herein, the data capture module 110 can run in the background and continuously capture data such as plant or refinery data as it becomes available, for example, while the plant or refinery is operating. As such, the captured data can include many more data points than data captured using manual or semi-automated techniques, as discussed below. Capturing more data points can allow trends to be identified earlier and corrections to the underlying model(s) to be made quicker than with existing technology, as discussed below. Indeed, such manual or semi-automated techniques can be unsuitable for taking advantage of high data density data sources. Additionally, continuous data capture and data screening (use of a process model to do automated data reconciliation, as described herein, can provide higher data density for predictive model validation than ad-hoc, manual, or semi-automated processes.

With continued reference to FIG. 2, at 203, a data storage module 120 can store the plant data. For purpose of illustration and not limitation, the data storage module 120 can store the data temporarily or permanently in any suitable storage medium, as discussed below. For example, and without limitation, the data can be stored in a memory, a database, or any other suitable storage medium. In some embodiments, the data storage module can include any suitable database, such as a structured query language (SQL) database or a Microsoft Access database, or any suitable storage medium, such as a local area network (LAN), a wide area network (WAN), a hard disk, etc., as described herein.

At 204, a data screening module 115 can screen the captured data. For purpose of illustration and not limitation, the data screening module 115 can screen data such as plant or refinery data directly after the data is captured by the data capture module 110 and before it is stored by the data storage module 120. Additionally or alternatively, the data can be screened by the data screening module 115 after the captured data is stored by the data storage module 120.

For purpose of illustration and not limitation, the data capture module 110, the data screening module 115, and the data storage module 120 can be implemented in one or more computers or computer systems, as discussed below. In some embodiments, the data capture module 110, the data screening module 115, and the data storage module 120 can be implemented using a single computer or computer system.

Additionally, and as embodied herein, the data screening module 115 can include a process modeling platform. For example, this process modeling platform can include a first principles, non-linear process model that can use plant data and data redundancy to reconcile the process model to screen the data to determine data quality, data consistency, and data quantity, as discussed below. This screened process model data can be provided to a validation module 130 before or after being stored by data storage module 120, as discussed further below. Additionally or alternatively, data quality above a threshold can include data that satisfies solution quality controls, which can include statistical methods such as confidence limits, a range of standard deviations, or any other suitable measures of data quality, as described herein. For purpose of illustration and not limitation, solution quality controls can include Design-of-Experiment (DOE) validity ranges, predictive model base vector, reference model base case, or average plant data. For example and not limitation, if the reconciliation fails to satisfy the solution quality controls, then the plant data can be determined to have insufficient data quality. Additionally, as embodied herein, if the data quality is not above the threshold, the plant data can be withheld from the predictive model. Alternatively, the plant data can be provided to the predictive model, and the plant data can be screened after the predicted yield is determined. Additionally or alternatively, the separate process model can provide any missing data not in the plant input data as a model-predicted value. As such, model-predicted values can be provided to the predictive model. Additionally, as embodied herein, screening plant input data can reduce the chance of outliers being used by the predictive model for validation purposes, as discussed herein.

In some embodiments, the data screening module 115 can screen the plant data to determine whether the plant data has sufficient data quality, for example, a data quality above a threshold. For purpose of illustration and not limitation, the data screening module 115 can use process model data from a separate first-principles, non-linear model, which can use data redundancy and model predictions to reconcile the data, for example plant data or refinery data, and can be performed before providing that data to the predictive model to be validated. In practice, plant data can be of poor quality. As such, the data screening module 115 can screen the data as described herein to improve the quality and quantity of available data.

For purposes of illustration and not limitation, data quality can be determined using statistical methods such as confidence limits, a range of standard deviations, or any other suitable techniques. For example, and as embodied herein, deviations can be measured as deviations from Design-of-Experiment (DOE) validity ranges, as discussed further below. Additionally or alternatively, deviations can be measured as deviations from predictive model base vector, deviations from reference model base case, and/or deviations from average plant data. These deviations can influence the ability of the predictive model to accurately predict the plant operation, for example, because they are deviations in the plant inputs provided to the predictive model. A predictive model base vector can include a superset of all base operating points for each of the inputs into the model. For purpose of illustration and not limitation, the predictive model can start from one of the base operating points and then shift or delta to the actual operating point from the base point. The base operating point(s) can be validated and updated. Additionally or alternatively, the predictive model can be based upon one or more separate detailed reference models, such as complex first-principles based phenomenological models, which can include but are not limited to molecular, property, hydrodynamic, economic and/or performance models. For purpose of illustration and not limitation, the predictive model can be based at least in part on a separate detailed reference model, as described herein. The reference model base case inputs can be modified to generate the lumps to be used in the predictive model, as described herein. The deviation of the plant data from the reference model base case inputs can determine whether the inputs provided to the predictive model are accurate. Additionally or alternatively, for any given measurement, the deviation can be measured from the average of all the plant data. Furthermore, and as embodied herein, the threshold for data quality can be static by unit, for example, when measuring deviations from DOE validity ranges, predictive model base vectors, or reference model base cases. Additionally or alternatively, the threshold for data quality can be dynamic based upon data, for example, when measuring deviations from average plant data. In some exemplary embodiments, the threshold for data quality can include data within two standard deviations of the mean of a data cluster. Data outside of two standard deviations can be determined to have insufficient data quality. Additionally or alternatively, a 95% confidence limit can be included in the threshold for data quality. Data outside of a 95% confidence limit can be determined to have insufficient data quality. In this manner, the data screening module 115 can screen out the data having insufficient data quality. Additionally or alternatively, other external factors can be used to determine the validity of the data. For example and not limitation, some or all units in the field can mass balance or material balance. A mass balance can be calculated based upon the raw (unscreened) data. If the mass balance of the raw data is unacceptable, that data set can be dropped, for example, because the data set would be too heavily manipulated for use in predictive model validation.

In some exemplary embodiments, the data screening module 115 can reconcile and mass-balance the data, e.g., plant or refinery data, before providing the data to the predictive model to be validated. For example, as embodied herein, the data screening module 115 can apply a first-principles model to all captured data automatically as the data is obtained, for example, online or in real time, by the data capture module 110 to reconcile the data. Such automated online or real-time data capture and data screening can reduce the effect of outliers on model validation results. Automated online or real-time data capture and data screening can also improve the quantity of the data available for predictive model validation. For purpose of comparison, a system using automated online or real-time techniques can obtain 50 or more data points per week. By contrast, ad-hoc, manual, or semi-automated processes can obtain data less frequently, e.g., 1-3 data points per week. The quality of the data captured and screened by such automated online or real-time techniques can be improved versus ad-hoc, manual, or semi-automated techniques of reconciling data. Additionally, such captured and screened data can have improved redundancy to ensure improved accuracy in the data provided for validation of the predictive model. In addition, the automated system can have the benefit of maintaining heat and material balance closure, as discussed below, which can improve accuracy of the information. Additionally or alternatively, after determining the predicted yield, the plant input data can be screened again, as described herein.

At 205, if the data quality of the data is above the threshold, the data can be provided to the predictive model. For purpose illustration and not limitation, the data can be provided to a validation module 130. For example, the data can be provided to the validation module 130 directly from the data capture module 110, via the data screening module 115, or via the data storage module 120. As embodied herein, captured and screened data such as plant or refinery data can be provided to the validation module via the data screening module 115. The validation module 130 can provide at least a portion of the data to the predictive model to be validated, which can include, for example and without limitation, the portion of the data with a data quality above the threshold. For purpose of illustration and not limitation, the input data can be supplied to the predictive model. For example, plant inputs can be provided to a plant predictive model.

For example, and as embodied herein, the predictive model can be developed from more detailed models, such as complex first-principles based phenomenological models, which can include but are not limited to molecular, property, hydrodynamic, economic and/or performance models. For purpose of illustration and not limitation, the predictive model can be developed from more detailed molecular based models, as discussed below. As discussed further below, the predictive model and the more detailed model can each have any suitable number of input variables. Additionally, as embodied herein, the predictive model can have less input variables than the more detailed model to enable calculating the results more efficiently. For example and not limitation, the detailed models can have thousands of input variables, whereas the predictive models can have less input variables, for example, less than 30 input variables. As such, and as embodied herein, detailed models can be more complex and can have a higher burden of computation than the predictive models. Additionally or alternatively, input data for the detailed models can be unavailable or relatively difficult to obtain in an online/real-time context. The predictive model structure can include input variables, for example and without limitation, plant or refinery inputs such as feed qualities and operating conditions, and mathematical relationships to output variables, for example and without limitation, plant outputs such as predicted unit yields or qualities. Coefficients and constants for the mathematical relationships and predictive models can be developed individually for each predictive model representation and thus vary from unit to unit. In some embodiments, an individual predictive model can be a non-linear or linear model. Additionally or alternatively, a predictive model can include a combination of sub-models, derived models, or process models, each of which can be a non-linear or linear model. Furthermore, individual sub-models, derived models, or process models can be integrated into a larger, refinery-wide, plant-wide, site-wide, or region-wide predictive model, and such an integrated model can be non-linear. A predictive model can be modified based upon the data processed by the model validation module 130. Exemplary modifications to predictive models can include adjustments to constants, coefficients, and/or biases generated by trends in the data.

Additionally, and as embodied herein, the predictive model can be derived using one or more complex first-principles based phenomenological models that can include but are not limited to molecular, property, hydrodynamic, economic and/or performance models. For purpose of illustration and not limitation, the predictive model can be derived using modeling or molecular modeling, for example, detailed, molecular-based modeling, as discussed below. Such modeling can be easier to run all the cases covering a suitably wide range that the plant might not have run in a recent pass.

For purpose of illustration and not limitation, the validation module 130 can be contained within the same platform as the original planning model platform. Exemplary original planning model platforms are discussed below. For example, if the original planning model platform used to create the derived models, process models, and/or sub-models was an optimization platform, that same optimization platform can be used as the validation module 130. Additionally or alternatively, the validation module 130 can be a separate or independent platform from the original planning model platform. For example, and as embodied herein, the validation module 130 can include a commercially available validation, optimization, and/or modeling platforms, as modified to incorporate the subject matter disclosed herein. Additionally or alternatively, the validation module 130 can include software, scripting, and/or programming, as described herein.

Any suitable number of interfaces can be included, and any suitable number of users can interact with the system. For example, the reporting interface 145 can be the same as or different from the user interface 140 used for model validation. A user 165 can interact with the reporting interface 145. The user 165 can be the same as or different from the user 160.

With continued reference to FIG. 2, at 206, the predictive model can determine at least one predicted output, such as a predicted yield, based on the data provided. For example and without limitation, a predictive model for a plant or refinery can determine a predicted yield, e.g., unit yields, qualities, or the like, based on the captured and screened plant data. As embodied herein, the predicted yields can be stored, for example, in a database 125. As discussed herein, the system can run automatically in the background, capturing and processing data as it becomes available. For example, and as embodied herein, an online or real-time system can capture, screen, and process input data and determine predicted yields and qualities.

At 207, the predicted yield can be compared to the data to determine if a deviation between the data and the predicted yield exceeds an acceptable error tolerance. For purpose of illustration and not limitation, the validation module 130 can compare the predicted yield to measured outputs from the data to determine if a deviation between the data and the predicted yield exceeds an acceptable error tolerance. For example, and as embodied herein, when validating a plant predictive model, the predicted yield can be compared to the plant outputs. As discussed herein, the predicted yield can include predicted unit yields, predicted qualities, or the like, and plant outputs can include unit yields, qualities, or the like. For purpose of illustration and not limitation, additional screening of the input data can be performed at this time, for example, using DOE validity ranges, predictive model base vector, reference model base case, and/or average plant data, as described herein.

Furthermore, and as embodied herein, the acceptable error tolerance can be predefined. Additionally or alternatively, an acceptable error tolerance can be dynamic. For example, a dynamic acceptable error tolerance can be based on historical prediction accuracies. For purposes of illustration and not limitation, error can be determined using statistical techniques such as confidence limits, a range of standard deviations, or any other suitable technique. For example, and as embodied herein, deviations can be measured as deviations from Design-of-Experiment (DOE) validity ranges, as discussed below. Additionally or alternatively, deviations can be measured as deviations from predictive model base vector, deviations from reference model base case, and/or deviations from average plant data. For purpose of illustration and not limitation, additional screening of the input data can be performed at this time, for example, using DOE validity ranges, predictive model base vector, reference model base case, and/or average plant data, as described herein. In some embodiments, the acceptable error tolerance can be static by unit such as when measuring deviations from DOE validity ranges, predictive model base vectors, or reference model base cases, as described herein. Additionally or alternatively, the acceptable error tolerance can be dynamic based upon data such as when measuring deviations from average plant data. For example, and as embodied herein, the acceptable error tolerance can include data within two standard deviations of the mean of a data cluster. Data outside of two standard deviations can be determined to be outside of the acceptable error tolerance. Additionally or alternatively, the acceptable error tolerance can be a 95% confidence limit. Data outside of a 95% confidence limit can be determined to be outside of the acceptable error tolerance. Thus, the validation module 130 can determine if a deviation between the data and the predicted yield exceeds an acceptable error tolerance. Additionally or alternatively, acceptable error tolerance can include a percent deviation between the predicted yield and the plant outputs, for example, more than 20% different, and the percent deviation can be configurable. Additionally or alternatively, the acceptable error tolerance can include whether the average plant data is within the DOE ranges.

For purpose of illustration and not limitation, the validation module 130 can perform a statistical comparison between the predicted outputs and the data. For example, and as embodied herein, when validating an exemplary plant predictive model, the validation module 130 can perform a statistical comparison between the predicted yields and qualities and the measured yields and qualities from the plant data. In some embodiments, the validation module 130 can determine the average deviation of the captured and screened data and compare that to the predicted outputs using a standard to represent the measurement error. The standard can be predefined or can be dynamic, for example and without limitation, based on historical prediction accuracies.

Furthermore, and as embodied herein, the validation module 130 can determine a suggested or recommended adjustment to the predictive model and a level of economic significance of the suggested adjustment, as discussed below. For purpose of illustration and not limitation, the suggested adjustment to the predictive model can be determined at least in part based on a model sensitivity analysis. For example, and as embodied herein, the model sensitivity analysis can include a model sensitivity matrix and/or a Monte Carlo analysis.

For purpose of illustration and not limitation, a Monte Carlo or Monte Carlo-like analysis of a sensitivity matrix of the predictive model can be used to determine whether the adjustment is economically significant. An exemplary Monte Carlo analysis can include running a series of randomized cases, which can include the deviation or measured error from the comparison discussed above. The scatter in the optimization objective function (e.g. profit) can be measured, and the effect of the predictive error on the planning economics can be estimated. This information can be used to prioritize updates to the predictive model based upon the estimated impact of an individual variable or relationship on the planning economics. As such, the Monte Carlo or Monte Carlo-like analysis can connect identified deviations with their economic significance. In this manner, the model validation and updating process can be focused and can provide direction as to which variables have the largest economic significance, e.g., the largest effect on the deviation or measured error.

Furthermore, and as embodied herein, the results of the comparison can be stored. For example, the data, the predicted result(s), the deviation(s), and/or the determination(s) of whether each deviation exceeds an acceptable error tolerance can be stored, e.g., in a memory, a database 125, or other suitable storage medium. The database 125 can include a SQL database. In addition, the data storage module 120 and the database 125 can be the same unit. Alternatively, the data storage module 120 and the database 125 can each be included in separate computers or computer systems connected directly or indirectly.

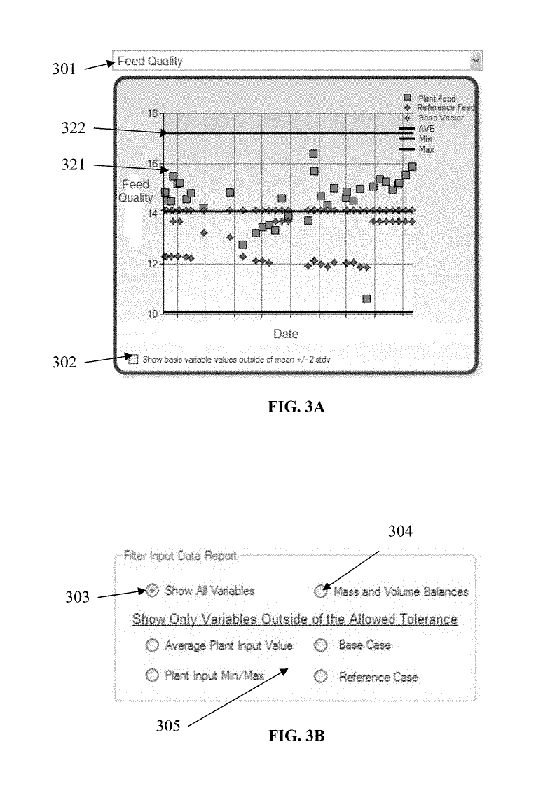

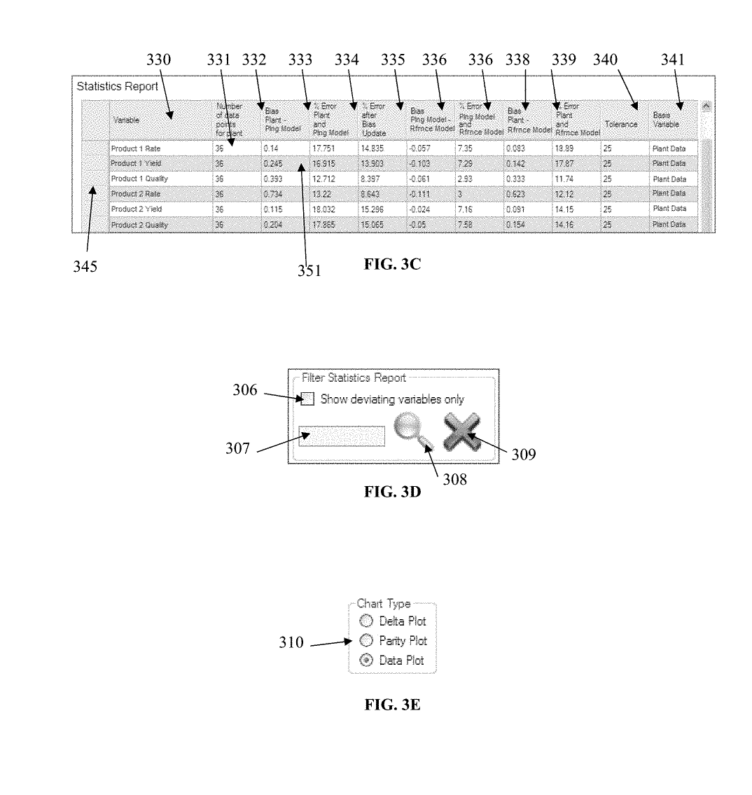

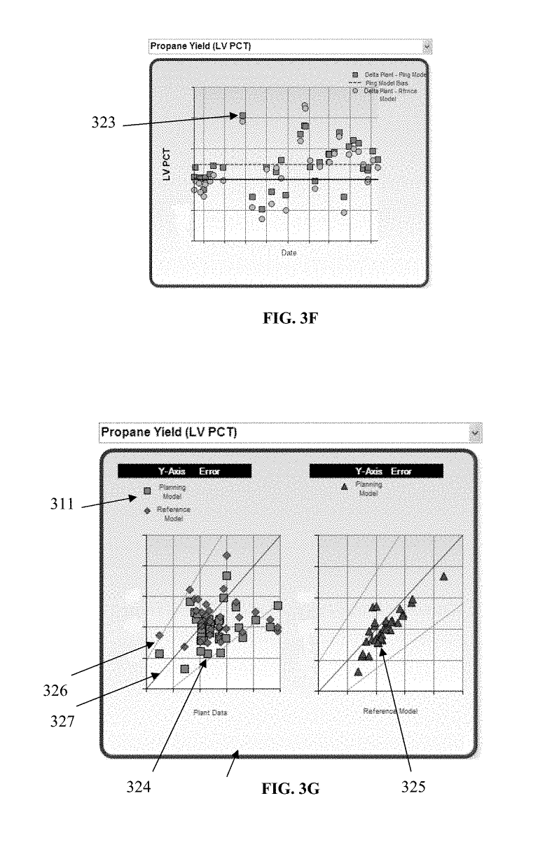

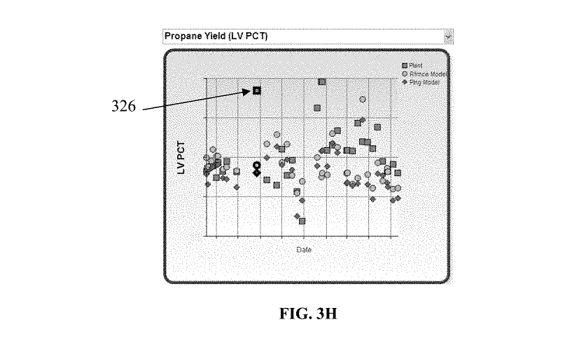

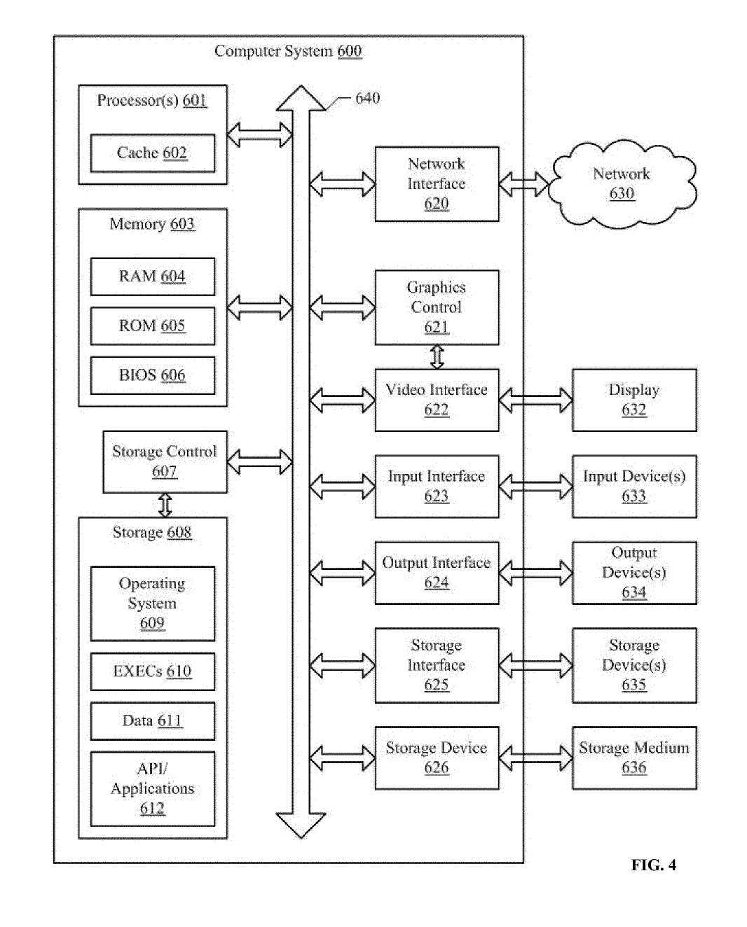

Additionally, and as embodied herein, the data and the information from the validation module 130 can be accessed by a user 160. For example, the data and the information from the validation module 130 can be provided to a user interface 140, either directly or indirectly, e.g., via the database 125. The user interface 140 can include data analysis and results visualization software. For purpose of illustration and not limitation, with reference to FIGS. 3A-3H, the user interface 140 can be used for input screening and output validation. For example, a user 160 can choose validation thresholds through the user interface 140, and the system can calculate biases and error measurements for each variable based on user input.

In addition, and as embodied herein, the user interface 140 can include data charting capabilities. For example, one or more types of data can be plotted to assess predictive model performance, including without limitation, reconciled (e.g., captured and screened) plant performance data, predictive model performance data, and a set of reference model data. In some embodiments, the reference model can be the same reference model from which the planning model was derived initially, as discussed below. Such data charting can give multiple representations of performance, and can be used by a user 160 to assess the accuracy of the predictive model. For example, the charts can visually represent statistics measuring predictive model data versus reconciled plant data. Additionally, and as embodied herein, interacting with the charts can provide further details for analysis. For example, interacting with the charts can include setting filters; clicking buttons, radio buttons, check-boxes, drop-down menus, or other graphical interface elements; entering a text query; or other suitable interactions.

For purpose of illustration and not limitation, FIGS. 3A, 3B, 3C, 3D, 3E, 3F, 3G, and 3H each is an exemplary image illustrating a representative graphical user interface 140 for use with the system of FIG. 1 and/or the method of FIG. 2 according to an illustrative embodiment of the disclosed subject matter. FIG. 3A shows an exemplary chart for viewing input data in accordance with some embodiments of the disclosed subject matter. As shown, a drop-down menu 301 can include a list of plots to view. A user 160 can interact with the drop-down menu, e.g., by clicking, to select a plot to view. The plot can include data points 321, and in some embodiments, the data points 321 can be interactive graphical interface elements. For purpose of illustration, a user 160 can hover a pointing device, e.g., a mouse, track pad, or touchscreen, over a data point 321 to view the value. Additionally or alternatively, the user 160 can interact with the data points 321 by clicking. For example, and as embodied herein, by left-clicking on a data point 321, a user 160 can label the data point 321 with its value. By right-clicking on the data point 321, the user 160 can access a filter menu, such as the filter menu depicted in FIG. 3B, as discussed further below. In addition, the plot can include a line or lines 322 depicting the threshold for data quality and/or the acceptable error tolerance, as discussed herein. In some embodiments, the plot can include a checkbox 302 that can be selected by the user 160, for example, to highlight one or more data points 321 outside of the threshold for data quality and/or the acceptable error tolerance, e.g., outside of mean plus or minus two standard deviations.

FIG. 3B shows an exemplary filter menu in accordance with some embodiments of the disclosed subject matter. An exemplary filter menu can include radio buttons 303, 304, and 305. For example, the radio button 303 can be selected by the user 160 to remove all filters on the input data plot and to view all variables. Additionally or alternatively, radio button 304 can be selected by the user 160 to filter the data grid to show all balances, e.g., material, mass, volume, and/or sulfur balance. As a further alternative, each of radio buttons 305 can be selected by the user 160 to match the input indicators. For purpose of illustration and not limitation, and as embodied herein, a user 160 can select a radio button 305 to filter the input data plot to show only variables outside of the allowed tolerance

FIG. 3C shows an exemplary chart for viewing model validation results data in accordance with some embodiments of the disclosed subject matter. A first column 330 can display a list of variables. In some embodiments, the margin 345 can be interactive. For example, and as embodied herein, a user 160 can click in the margin 345 to view a data plot, such as the data plot depicted in FIG. 3A, for the variable in the selected row of column 330. Additionally or alternatively, the user 160 can click in the margin or use, e.g., the left and right arrow keys on a keyboard to highlight a selected row of the chart, and the user 160 can use, e.g., the up and down arrow keys on a keyboard to navigate through plots for the variables of each row of the chart. A second column 331 can display the number of data points available for each variable listed in first column 330. The number can be the same or different between variables, for example, due to data screening and/or filtering. A third column 332 can display the recommended bias for plant data and the reference model base case for each variable listed in first column 330. For example and not limitation, this bias can be calculated by subtracting the average planning model prediction from the average plant data for a given variable. A fourth column 333 can display the percent error between plant data and the planning model. A fifth column 334 can display a recalculation of the percent error between plant data and the planning model if the recommended bias from column 332 is applied. Such recalculation can be used to determine if a recommended bias update is a sufficient way to reduce the error. A sixth column 335 can display the recommended bias for the reference model and planning model for each variable listed in column 330. For example and not limitation, this bias can be calculated by subtracting the average planning model prediction from the average reference model prediction for a given variable. A seventh column 336 can display a recalculation of the percent error between reference model prediction and the planning model if the recommended bias from sixth column 335 is applied, and this recalculation likewise can be used to determine if a recommended bias update is a sufficient way to reduce the error. An eighth column 337 can display the recommended bias for plant data and the reference model for each variable listed in column 330. For example and not limitation, this bias can be calculated by subtracting the average reference model prediction from the average plant data for a given variable. A ninth column 338 can display a recalculation of the percent error between plant data and reference model if the recommended bias from eighth column 337 is applied. This recalculation can also be used to determine if a recommended bias update is a sufficient way to reduce the error. A tenth column 339 can display the type of variable, and the eleventh column 340 can display the threshold for data quality and/or acceptable error tolerance for each variable. For example, if a percent error listed in a cell, such as cell 351, in one or more of columns 333, 334, 336, and/or 338 is greater than the threshold/tolerance listed in column 340, the cell 351 displaying that particular percent error can indicate exceeding the threshold/tolerance, for example, by displaying the text in a different color (e.g. red), changing the font (e.g. bold or italics), or any other suitable indication. A column 341 can display the basis variable, e.g., the source of the plant data, such as a table, for the validation variable listed in column 330.

FIG. 3D shows an exemplary filter menu in accordance with some embodiments of the disclosed subject matter. As embodied herein, the filter menu depicted in FIG. 3D can be used to filter the data in a chart of statistical data or model validation results data such as the chart depicted in FIG. 3C. A checkbox 306 can be selected by the user 160 to filter the chart of statistical data or model validation results data to show only the variables where the percent error between plant data and model prediction is outside the tolerance/threshold. The user 160 can enter a text string into a textbox 307 can be used to filter the chart of statistical data or model validation results data to only show variables containing the text string (e.g. “LCN” or “yield”). In some embodiments, a button or icon, such as search icon 308, can be selected to apply the text filter. Additionally or alternatively, a button or icon, such as “X” icon 309, can be selected to remove the text filter.

FIG. 3E shows an exemplary selection menu in accordance with some embodiments of the disclosed subject matter. Radio buttons 310 can be selected by the user 160 to view plots of model validation results data, such as a delta plot (as shown in FIG. 3F), a parity plot (as shown in FIG. 3G), and/or a data plot (as shown in FIG. 3H). Additionally or alternatively, the user can select, e.g., but double-clicking, each of the plots above to switch between the types of plots. FIG. 3F shows an exemplary delta plot in accordance with some embodiments of the disclosed subject matter. As shown, a delta plot can include data points 323. In some embodiments, the user 160 can right-click a data point 323 to identify the date and time of that point. Additionally or alternatively, the user 160 can right-click a data point 323 to bring up a menu with options such as finding the corresponding point in a data plot.

FIG. 3G shows an exemplary parity plot in accordance with some embodiments of the disclosed subject matter. As shown, the parity plot can include data points 324 and data points 325. In some embodiments, the user 160 can right-click a data point 324 or data point 325 to identify the date and time of that point. Additionally or alternatively, the user 160 can right-click a data point 324 or data point 325 to bring up a menu with options such as finding the corresponding point in a data plot. The parity plot can also include axis labels, such as y-axis labels 311. The parity plot can also include check boxes, each of which can be checked or un-checked by the user 160 to add or remove, respectively, a series of data from the chart. Exemplary series of data can include the planning model, the planning model with a recommended bias applied, reference model, and planning model versus reference. In some embodiments, the parity plot can also include the mean 327 and threshold/tolerance 326 for the data points 324 or 325.

FIG. 3H shows an exemplary data plot in accordance with some embodiments of the disclosed subject matter. As shown, the data plot can include data points 326. In some embodiments, data points 326 can correspond to data points 323, 324, and/or 325 in a delta plot and/or parity plot.

Referring again to FIG. 2, at 208, an alert 150 can be sent if the deviation exceeds the acceptable error tolerance. For example, alert 150 can include one or more of an email alert, message box, or other suitable alert can be sent by the validation module 130 and/or the user interface 140. In operation, the alert can be sent to a user 160, such as an economist, process engineer, model owner, or the like. For purpose of illustration and not limitation, the alert can display at least one suggested adjustment, such as a recommended bias for plant data and the planning model, a recommended bias for the reference model and planning model, and/or a recommended bias for plant data and the reference model data, as discussed herein. Additionally or alternatively, the alert can indicate the level of economic significance, e.g., improvement in prediction accuracy, with and without the suggested adjustment, for example the percent error with and without each recommended bias applied, as discussed herein. Furthermore, and as embodied herein, the suggested adjustment and level of economic significance can be based on a model sensitivity analysis, e.g. a Monte Carlo-like analysis of a sensitivity matrix of the predictive model, as discussed herein.

For purposes of illustration and not limitation, the acceptable error tolerances can be static, as discussed herein. Additionally or alternatively, an acceptable error tolerance can be dynamic, as discussed herein. In some embodiments, the acceptable error tolerance can be based on historical prediction accuracies.

Additionally, and as embodied herein, the validation of the predictive model can run in the background and can continuously validate the predictive model and send alerts, for example, while the plant or refinery is operating. The continuous and automatic validation can result in the predictive model being more up-to-date and more accurate compared to ad-hoc, manual, or semi-automated methods of validating predictive models. More accurate and up-to-date predictive models can, for example, allow for better economic decisions.

Referring again to FIG. 2, at 209, an instruction whether to update the predictive model can be generated and/or received in response to the alert. For example, and as embodied herein, the user 160 can provide the instruction whether to update the predictive model, such as by using the user interface 140. Additionally or alternatively, the instruction whether to update the predictive model can be generated by the system, e.g., by the validation module 130 or user interface 140. In addition, the instruction whether to update can be based on the indications of prediction accuracy with and without the adjustment, as discussed herein. For example and not limitation, the recommended adjustment to the predictive model can included new values or changes/deltas to existing values.

At 210 the predictive model can be adjusted to reduce the deviation, for example, in response to an instruction to update the predictive model. As embodied herein, the recommended adjustment provided with the alert can be implemented, e.g., by the user interface 140 or the validation module 130. In some embodiments, the adjustment can include a recommended bias for plant data and the planning model, a recommended bias for the reference data and planning model, and/or a recommended bias for plant data and reference model, as discussed herein.

The systems and techniques discussed herein can be implemented in a computer system. For example, the system can include a plant control computer; a database; at least one computer configured to screen the plant data, generate predicted yields based on the plant data and the predictive model, compare the predicted yields to the plant data, send the alert, and adjust the predictive model, as described herein. As an example and not by limitation, as shown in FIG. 4, the computer system having architecture 600 can provide functionality as a result of processor(s) 601 executing software embodied in one or more tangible, computer-readable media, such as memory 603. The software implementing various embodiments of the present disclosure can be stored in memory 603 and executed by processor(s) 601. A computer-readable medium can include one or more memory devices, according to particular needs. Memory 603 can read the software from one or more other computer-readable media, such as mass storage device(s) 635 or from one or more other sources via communication interface. The software can cause processor(s) 601 to execute particular processes or particular parts of particular processes described herein, including defining data structures stored in memory 603 and modifying such data structures according to the processes defined by the software. An exemplary input device 633 can be, for example, the flow instruments, temperature sensors, pressure sensors, or the like to measure and gather data or keyboards, pointing devices, or the like to capture user input coupled to the input interface 623 to provide data and/or user input to the processor 601. An exemplary output device 634 can be, for example, a display, such as a monitor, coupled to the output interface 623 to allow the processor 601 to present the user interface 140. Additionally or alternatively, the computer system 600 can provide an indication to the user by sending text or graphical data to a display 632 coupled to a video interface 622. Furthermore, any of the above components can provide data to or receive data from the processor 601 via a computer network 630 coupled the network interface 620 of the computer system 600. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

For purpose of illustration and not limitation, an exemplary predictive model can include a large scale Optimizable Refinery Model (ORM) used to make crude purchase and run planning decisions. An ORM can include an integrated network of sub-models such as process and blending modules. The ORM can be driven by an objective function, for example, net margin. For example, the ORM can receive one or more potential inputs, e.g., feeds such as crudes, and/or feedstocks, and potential outputs, e.g., products such as various grades of gasoline, distillates, fuel oils, lubes, and/or specialties, and can calculate an enhanced feed mix and product slate. An ORM can further include various elements such as feed quality data (e.g., assay data), process models, economic inputs (e.g., prices and availability of feedstocks and products), plant constraints, and an optimization platform

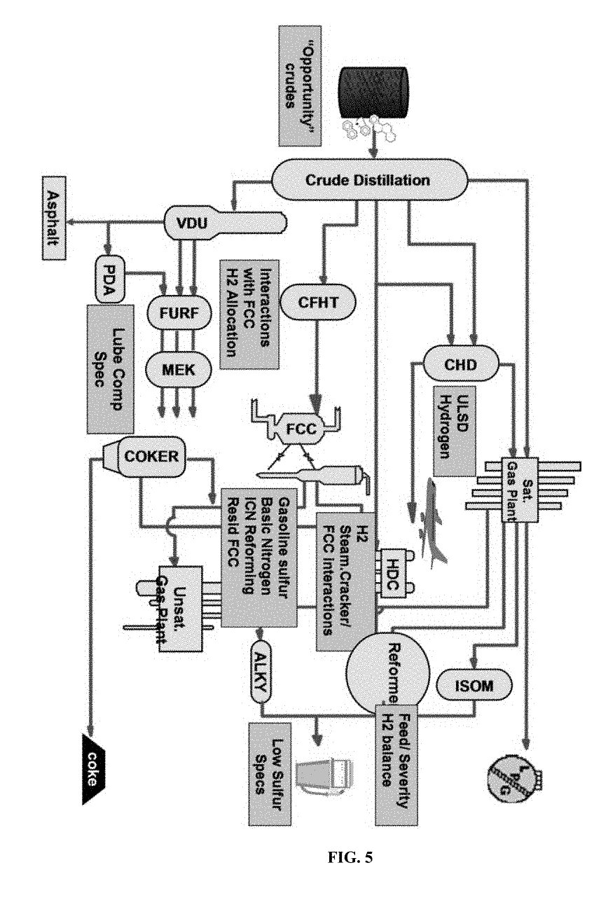

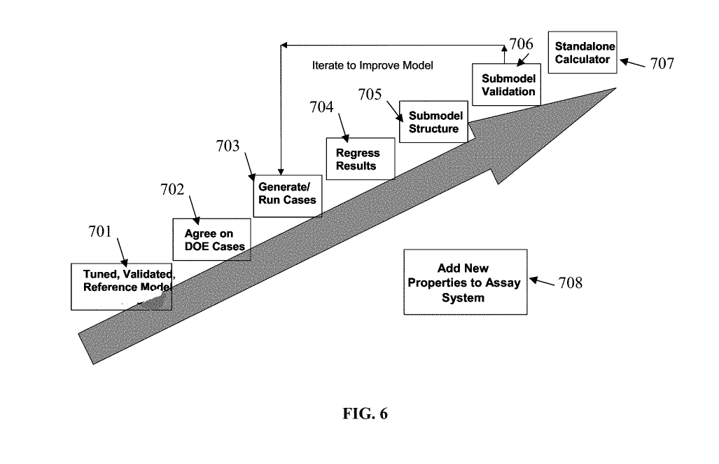

FIG. 5 shows exemplary opportunity areas for more detailed ORMs. For example, predictive models, such as more detailed ORMs, can be used to enhance crude distillation, VDU (vacuum distillation unit), asphalt, PDA (propane deasphalter), FURF (furfural solvent extraction unit), MEK (mek solvent dewaxing unit), coker, unsaturated gas plants, CFHT (cat feed hydrotreater), fluid catalytic cracking (FCC), ALKY (alkylation), CHD (catalytic hydrodesulfurization unit), saturated gas plant, HDC (hydrocracker), reformer, ISOM (isomerization unit). Benefits of more detailed modeling can include more accurate modeling of opportunity crudes, ultra low sulfur mogas and diesel, catalytic naphtha reforming, refinery/chemicals interfaces, and catalytic feed hydrotreater/FCC interactions, steam cracker/FCC interactions, H2 allocation, Lube production and quality, ULSD (ultra-low sulfur diesel) hydrogen, gasoline sulfur predictions, basic nitrogen impacts, ICN reforming economics, and resid FCC economics.

For purpose of illustration and not limitation, an exemplary predictive model can include sub-models or reference models, such as one or more complex first-principles based phenomenological models, which can include but are not limited to molecular, property, hydrodynamic, economic and/or performance models.

The reference models can be accurate over a wide range of feeds and operating conditions. In operation, the reference models can be too large or computationally burdensome to effectively use in planning and scheduling models. As such, to manage the computational burden for a predictive model such as an ORM, one or more derived models can be built. A derived model can include a correlation based on the reference model over a range of inputs, such as feeds and operating conditions of interest to the refinery. The appropriate level of derived model complexity can be driven by the benefit-to-cost ratio, based at least in part on the requirements for the specific business application. Model accuracy can be balanced with speed, usability (including analysis time), and robustness.

For purpose of illustration and not limitation, reference models can be used to generate simplified predictive models to include in offline optimization processes. FIG. 6 illustrates exemplary techniques to develop a derived model from a tuned reference model. With reference to FIG. 6, at 701, a reference model can be tuned and validated. At 702, a design of experiments (DOE) range can be selected and/or agreed upon, for example, in consultation with the plant. The DOE can be the range of inputs (e.g. feeds and operating conditions) over which the reference model can be exercised to build the fit-for-purpose derived model. In some instances, the DOE range can be broader than typical plant operations to develop a robust derived model.

At 703, a number of reference model cases can be generated and run to cover the range of feeds and operating conditions within the DOE. In some embodiments, the number of reference model cases can be 1,000 or more. At 704, the reference model cases can be screened to eliminate un-converged cases or cases that are outside the range of interest. The remaining cases can be regressed to develop the derived model regressions. For purpose of illustration and not limitation, the set of DOE cases can be stored, for example, in a database. The set of DOE cases can be randomly divided into a training set and a validation set. In some embodiments, the training set can be 80% of the DOE cases, while the validation set can be the remaining 20% of the DOE cases. A regression, for example a Principal Component Analysis (PCA) regression, can be performed on the training set to calculate a suitable fit for the coefficients in the derived model equations. The coefficients then can be tested against the cases in the validation set. At 705, the derived model or sub-model structure can be further refined for specific applications, as desired.

With continued reference to FIG. 6, at 706, the derived model can be validated by examining the results. For example, the derived model can be validated as described herein. Additionally or alternatively, the derived model can be validated according to one or more exemplary techniques, as follows. For example, as embodied herein, the derived model predictions for each of the DOE cases can be tested against the reference model predictions with parity plots for training and validation datasets. Additionally or alternatively, the derived model prediction trends can be checked against the reference model prediction trends to determine whether the derived model predictions are consistent with those of the reference model for exemplary perturbations in inputs, such as perturbations in operating conditions and feeds. Additionally or alternatively, the derived model predictions can be compared with measured data, for example, plant or refinery data not used to tune the reference model. The steps of generate/run cases (FIG. 6 at 703), regression (FIG. 6 at 704), sub-model structure (FIG. 6 at 705), and/or sub-model validation (FIG. 6 at 706) can be iterated to improve the derived model.

With reference to FIG. 6, at 707, a validated derived model can be incorporated into a larger predictive model such as an ORM. For example, the derived model can be added to the planning and scheduling tools. A derived model incorporated into a larger predictive model can be referred to as a sub-model. In addition, the derived models can be used to develop calculators to test the larger predictive model outside of the production environment.

At 708, new properties can be added to the derived models at any time during the process, for example, as suitable for a particular business need or as new information becomes available. For example and not limitation, new properties can be added to the assay systems described herein to integrate the new derived model and its associated inputs into the planning model.

Automated tools can be used to generate DOE reference model cases, store reference model DOE case outputs, regress derived model coefficients, and graph results, as discussed herein. For purpose of illustration and not limitation, crude fractionation sub-models in an exemplary ORM predictive model can be defined using the so-called “heart-and-swing cut” methodology to divide each crude into discrete boiling ranges with crude-specific yields and qualities for each “cut.” In this manner, the whole crude can be divided into “heart cuts” and “swing cuts.” Heart cuts can include crude fractions with relatively wide boiling ranges which form the “heart” of a crude fractionation tower side-stream. Swing cuts can include crude fractions with relatively narrow boiling ranges which can “swing” into an adjacent heart cut. A typical crude fractionation tower structure can include alternating heart and swing cuts, for example, covering the entire crude oil boiling range.

The tuning process for crude fractionation towers can be modified from the technique described above for conversion sub-models. In some embodiments, there can be no need to run multiple DOE cases to simplify the reference model, as each crude can be discretely modeled using a specific crude assay. Exemplary parameters, which can be used to define the sub-model, can include boiling ranges for each side stream and the fractionation efficiency between side streams. Values identified for a specific crude fractionating tower can be used in conjunction with, for example, a database of crude assays to predict yields and qualities (including lumps) of each heart and swing cut for each crude in the ORM predictive model. Such heart-and-swing-cut and crude fractionation sub-model then can be compared to plant data to validate yield and qualities. An accurate representation of crude fractionation towers can be used in defining the volumes and qualities of streams feeding conversion units and blending models in the ORM predictive model.

For purposes of illustration and not limitation, a derived model can be of the form: y=base+k1*shift+k2*shift . . . +k10*cross terms or non-linear terms. The independent variables (written as shift terms) can include, but not limited to, stream rates, operating conditions (e.g. reactor temperature) and feed qualities, both physical inspection properties (e.g. specific gravity) and molecular “lumps” determined by START technology, as described for example in commonly assigned U.S. Pat. No. 8,114,678 to Chawla et al. The description of U.S. Pat. No. 8,114,678 is incorporated herein in its entirety. Depending upon the optimization solver employed, model equations will be formulated to best function in that given optimization environment.

The derived models described herein can be advantageous, for example, for implementing more detailed modeling in offline or online optimization tools for planning and scheduling. Together with other tools, more detailed modeling can result in improved accuracy of predictions of outputs, e.g., conversion unit product yields and qualities, over a wider range of inputs. The techniques described herein can improve raw material flexibility and refinery stream dispositions more effectively among processing units, sub-models, or derived models, for example, for fuels, lubes, and chemicals. For example, multi-plant optimization models can enable enhancement of integrated sites on a regional basis.

For purpose of illustration and not limitation, more detailed modeling can be implemented in offline optimization planning and scheduling tools. Changes to modeling can be suitable, for example, to accommodate more stringent product specifications and increasingly diverse raw material supplies. A multi-step work process can be employed to derive robust sub-models and larger predictive models from detailed, kinetic reference models. Sub-models can be developed for potentially any unit within the plant or refinery. Exemplary more detailed models can result in more accurate predictions of outputs, such as conversion unit product yields and qualities, over a wider range of inputs, such as feed composition and operating space, compared to conventional models.

### Additional Embodiments

Additionally or alternately, the invention can include one or more of the following embodiments.

Embodiment 1: A method for validation of a predictive model, comprising providing a predictive model, capturing plant data, storing the plant data, screening the plant data to determine whether the plant data has a data quality above a threshold, if the data quality of the plant data is above a threshold, supplying the plant data to the predictive model, determining by the predictive model a predicted yield based on the plant data, comparing the predicted yield to the plant data to determine if a deviation between the plant data and the predicted yield exceeds an acceptable error tolerance, and sending an alert if the deviation exceeds the acceptable error tolerance.

Embodiment 2: The method of Embodiment 1, wherein the predictive model comprises a non-linear process model.

Embodiment 3: The method of Embodiment 2, wherein the non-linear process model comprises a plurality of unit representations.

Embodiment 4: The method of any of the foregoing Embodiments, wherein capturing plant data comprises capturing plant data by at least one of a control computer or a data historian.

Embodiment 5: The method of any of the foregoing Embodiments, wherein storing the plant data comprises storing the plant data in a database.

Embodiment 6: The method of any of the foregoing Embodiments, wherein the plant data comprises plant inputs and plant outputs.

Embodiment 7: The method of Embodiment 6, wherein the plant inputs comprise at least one of feed properties or operating conditions.

Embodiment 8: The method of Embodiment 6 or 7, wherein the plant outputs comprise at least one of unit yields or qualities.

Embodiment 9: The method of any of the foregoing Embodiments, wherein screening the plant data comprises reconciling the plant data based on a separate process model.

Embodiment 10: The method of any of the foregoing Embodiments, wherein data quality above a threshold comprises one of data within a 95% confidence limit or data within twice the standard deviation from the average.

Embodiment 11: The method of any of Embodiments 6-8, wherein supplying the plant data to the predictive model comprises supplying the plant inputs to the predictive model.

Embodiment 12: The method of any of the foregoing Embodiments, wherein the predicted yield comprises at least one of predicted unit yields or predicted qualities.

Embodiment 13: The method of any of Embodiments 6-8 or 11, wherein comparing the predicted yield to the plant data comprises comparing the predicted yield to the plant outputs.

Embodiment 14: The method of Embodiment 13, wherein the predicted yield comprises at least one of predicted unit yields or predicted qualities, and further wherein the plant outputs comprise at least one of unit yields or qualities.

Embodiment 15: The method of any of the foregoing Embodiments, wherein comparing the plant data comprises comparing the the plant data to against various model derivation bases to determine a deviation from one of Design-of-Experiment (DOE) validity ranges, predictive model base vector, reference model base case, or average plant data.

Embodiment 16: The method of any of the foregoing Embodiments, wherein the acceptable error tolerance comprises one of a 95% confidence limit or twice the standard deviation from the average.

Embodiment 17: The method of any of the foregoing Embodiments, wherein comparing the predicted yield to the plant data further comprises determining a suggested adjustment to the predictive model and a level of economic significance of the suggested adjustment.

Embodiment 18: The method of Embodiment 17, wherein determining the suggested adjustment to the predictive model comprises determining the suggested adjustment to the predictive model and the level of economic significance of the suggested adjustment based on a model sensitivity analysis.

Embodiment 19: The method of Embodiment 18, wherein the model sensitivity analysis comprises at least one of a model sensitivity matrix or a Monte Carlo analysis.

Embodiment 20: The method of any of Embodiments 17-19, wherein the alert comprises the suggested adjustment to the predictive model and the level of economic significance of the suggested adjustment.

Embodiment 21: The method of Embodiment 20, wherein the suggested adjustment to the predictive model and the level of economic significance of the suggested adjustment are based on a model sensitivity analysis.

Embodiment 22: The method of Embodiment 21, wherein the model sensitivity analysis comprises at least one of a model sensitivity matrix or a Monte Carlo analysis.

Embodiment 23: The method of any of the foregoing Embodiments, further comprising, in response to the alert, receiving an instruction whether to update the predictive model.

Embodiment 24: The method of Embodiment 23, further comprising, if the instruction is to update the predictive model, adjusting the predictive model to reduce the deviation.

Embodiment 25: A system for validation of a predictive model, comprising one or more processors and one or more non-transitory computer readable storage media embodying software that is configured when executed by one or more of the processors to provide a predictive model, capture plant data, store the plant data, screen the plant data to determine whether the plant data has a data quality above a threshold, if the data quality of the plant data is above a threshold, supply the plant data to the predictive model, determine by the predictive model a predicted yield based on the plant data, compare the predicted yield to the plant data to determine if a deviation between the plant data and the predicted yield exceeds an acceptable error tolerance, and send an alert if the deviation exceeds the acceptable error tolerance.

Embodiment 26: The system of Embodiment 25 configured for use in accordance with any of the methods described in Embodiments 1 through 24.

Embodiment 27: A non-transitory computer readable medium comprising a set of executable instructions to direct a processor to provide a predictive model, capture plant data, store the plant data, screen the plant data to determine whether the plant data has a data quality above a threshold, if the data quality of the plant data is above a threshold, supply the plant data to the predictive model, determine by the predictive model a predicted yield based on the plant data, compare the predicted yield to the plant data to determine if a deviation between the plant data and the predicted yield exceeds an acceptable error tolerance, and send an alert if the deviation exceeds the acceptable error tolerance.

Embodiment 28: The non-transitory computer readable medium of Embodiment 27 configured for use in accordance with any of the methods described in Embodiments 1 through 24.

While the disclosed subject matter is described herein in terms of certain preferred embodiments, those skilled in the art will recognize that various modifications and improvements can be made to the disclosed subject matter without departing from the scope thereof. Moreover, although individual features of one embodiment of the disclosed subject matter can be discussed herein or shown in the drawings of the one embodiment and not in other embodiments, it should be apparent that individual features of one embodiment can be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. A method for automatic validation of a predictive model, comprising:
providing a predictive model;
capturing plant data;
storing the plant data;
screening the plant data to determine whether the plant data has a data quality above a threshold;
if the data quality of the plant data is above a threshold, supplying the plant data to the predictive model;
determining by the predictive model a predicted yield based on the plant data;
comparing the predicted yield to the plant data to determine if a deviation between the plant data and the predicted yield exceeds an acceptable error tolerance; automatically sending an alert if the deviation exceeds the acceptable error tolerance.

2. The method of claim 1, wherein the predictive model comprises a non-linear process model.

3. The method of claim 2, wherein the non-linear process model comprises a plurality of unit representations.

4. The method of claim 1, wherein capturing plant data comprises capturing plant data by at least one of a control computer or a data historian.

5. The method of claim 1, wherein storing the plant data comprises storing the plant data in a database.

6. The method of claim 1, wherein the plant data comprises plant inputs and plant outputs.

7. The method of claim 6, wherein the plant inputs comprise at least one of feed properties or operating conditions.

8. The method of claim 6, wherein the plant outputs comprise at least one of unit yields or qualities.

9. The method of claim 1, wherein screening the plant data comprises reconciling the plant data based on a separate process model.

10. The method of claim 1, wherein data quality above a threshold comprises one of data within a 95% confidence limit or data within twice the standard deviation from the average.

11. The method of claim 6, wherein supplying the plant data to the predictive model comprises supplying the plant inputs to the predictive model.

12. The method of claim 1, wherein the predicted yield comprises at least one of predicted unit yields or predicted qualities.

13. The method of claim 6, wherein comparing the predicted yield to the plant data comprises comparing the predicted yield to the plant outputs.

14. The method of claim 13, wherein the predicted yield comprises at least one of predicted unit yields or predicted qualities, and further wherein the plant outputs comprise at least one of unit yields or qualities.

15. The method of claim 1, wherein comparing the predicted yield to the plant data comprises comparing the predicted yield to the plant data to determine a deviation from one of Design-of-Experiment (DOE) validity ranges, predictive model base vector, reference model base case, or average plant data.

16. The method of claim 1, wherein the acceptable error tolerance comprises one of a 95% confidence limit or twice the standard deviation from the average.

17. A method for validation of a predictive model, comprising:
providing a predictive model;
capturing plant data;
storing the plant data;
screening the plant data to determine whether the plant data has a data quality above a threshold;
if the data quality of the plant data is above a threshold, supplying the plant data to the predictive model;
determining by the predictive model a predicted yield based on the plant data;
comparing the predicted yield to the plant data to determine if a deviation between the plant data and the predicted yield exceeds an acceptable error tolerance; automatically sending an alert if the deviation exceeds the acceptable error tolerance, wherein comparing the predicted yield to the plant data further comprises determining a suggested adjustment to the predictive model and a level of economic significance of the suggested adjustment.

18. The method of claim 17, wherein determining the suggested adjustment to the predictive model comprises determining the suggested adjustment to the predictive model and the level of economic significance of the suggested adjustment based on a model sensitivity analysis.

19. The method of claim 18, wherein the model sensitivity analysis comprises at least one of a model sensitivity matrix or a Monte Carlo analysis.

20. The method of claim 17, wherein the alert comprises the suggested adjustment to the predictive model and the level of economic significance of the suggested adjustment.

21. The method of claim 20, wherein the suggested adjustment to the predictive model and the level of economic significance of the suggested adjustment are based on a model sensitivity analysis.

22. The method of claim 21, wherein the model sensitivity analysis comprises at least one of a model sensitivity matrix or a Monte Carlo analysis.

23. The method of claim 17, wherein the predictive model comprises a non-linear process model.

24. The method of claim 23, wherein the non-linear process model comprises a plurality of unit representations.

25. The method of claim 17, wherein capturing plant data comprises capturing plant data by at least one of a control computer or a data historian.

26. The method of claim 17, wherein storing the plant data comprises storing the plant data in a database.

27. The method of claim 17, wherein the plant data comprises plant inputs and plant outputs.

28. The method of claim 27, wherein the plant inputs comprise at least one of feed properties or operating conditions.

29. The method of claim 27, wherein the plant outputs comprise at least one of unit yields or qualities.

30. The method of claim 17, wherein screening the plant data comprises reconciling the plant data based on a separate process model.

31. The method of claim 17, wherein data quality above a threshold comprises one of data within a 95% confidence limit or data within twice the standard deviation from the average.

32. The method of claim 27, wherein supplying the plant data to the predictive model comprises supplying the plant inputs to the predictive model.

33. The method of claim 17, wherein the predicted yield comprises at least one of predicted unit yields or predicted qualities.

34. The method of claim 27, wherein comparing the predicted yield to the plant data comprises comparing the predicted yield to the plant outputs.

35. The method of claim 34, wherein the predicted yield comprises at least one of predicted unit yields or predicted qualities, and further wherein the plant outputs comprise at least one of unit yields or qualities.

36. The method of claim 17, wherein comparing the predicted yield to the plant data comprises comparing the predicted yield to the plant data to determine a deviation from one of Design-of-Experiment (DOE) validity ranges, predictive model base vector, reference model base case, or average plant data.

37. The method of claim 17, wherein the acceptable error tolerance comprises one of a 95% confidence limit or twice the standard deviation from the average.

38. The method of claim 1, further comprising:
in response to the alert, receiving an instruction whether to update the predictive model.

39. The method of claim 38, further comprising:
if the instruction is to update the predictive model, adjusting the predictive model to reduce the deviation.

40. A system for validation of a predictive model, comprising:
one or more processors; and
one or more non-transitory computer readable storage media embodying software that is configured when executed by one or more of the processors to:
provide a predictive model;
capture plant data;
store the plant data;
screen the plant data to determine whether the plant data has a data quality above a threshold;
if the data quality of the plant data is above a threshold, supply the plant data to the predictive model;
determine by the predictive model a predicted yield based on the plant data;
compare the predicted yield to the plant data to determine if a deviation between the plant data and the predicted yield exceeds an acceptable error tolerance; and
automatically send an alert if the deviation exceeds the acceptable error tolerance.

41. The system of claim 40, wherein the predictive model comprises a non-linear process model.

42. The system of claim 41, wherein the non-linear process model comprises a plurality of unit representations.

43. The system of claim 40, wherein capture plant data comprises capture plant data by at least one of a control computer or a data historian.

44. The system of claim 40, wherein store the plant data comprises store the plant data in a database.

45. The system of claim 40, wherein the plant data comprises plant inputs and plant outputs.

46. The system of claim 45, wherein the plant inputs comprise at least one of feed properties or operating conditions.

47. The system of claim 45, wherein the plant outputs comprise at least one of unit yields or qualities.

48. The system of claim 40, wherein screen the plant data comprises reconciling the plant data based on a separate process model.

49. The system of claim 40, wherein data quality above a threshold comprises one of data within a 95% confidence limit or data within twice the standard deviation from the average.

50. The system of claim 45, wherein supply the plant data to the predictive model comprises supply the plant inputs to the predictive model.

51. The system of claim 40, wherein the predicted yield comprises at least one of predicted unit yields or predicted qualities.

52. The system of claim 45, wherein compare the predicted yield to the plant data comprises compare the predicted yield to the plant outputs.

53. The system of claim 52, wherein the predicted yield comprises at least one of predicted unit yields or predicted qualities, and further wherein the plant outputs comprise at least one of unit yields or qualities.

54. The system of claim 40, wherein compare the predicted yield to the plant data comprises compare the predicted yield to the plant data to determine a deviation from one of Design-of-Experiment (DOE) validity ranges, predictive model base vector, reference model base case, or average plant data.

55. The system of claim 40, wherein the acceptable error tolerance comprises one of a 95% confidence limit or twice the standard deviation from the average.

56. The system of claim 40, wherein compare the predicted yield to the plant data further comprises determine a suggested adjustment to the predictive model and a level of economic significance of the suggested adjustment.

57. The system of claim 56, wherein determine the suggested adjustment to the predictive model comprises determine the suggested adjustment to the predictive model and the level of economic significance of the suggested adjustment based on a model sensitivity analysis.

58. The system of claim 57, wherein the model sensitivity analysis comprises at least one of a model sensitivity matrix or a Monte Carlo analysis.

59. The system of claim 56, wherein the alert comprises the suggested adjustment to the predictive model and the level of economic significance of the suggested adjustment.

60. The system of claim 59, wherein the suggested adjustment to the predictive model and the level of economic significance of the suggested adjustment are based on a model sensitivity analysis.

61. The system of claim 60, wherein the model sensitivity analysis comprises at least one of a model sensitivity matrix or a Monte Carlo analysis.

62. The system of claim 40, wherein the software is further configured to:
in response to the alert, receive an instruction whether to update the predictive model.

63. The system of claim 62, wherein the software is further configured to:
if the instruction is to update the predictive model, adjust the predictive model to reduce the deviation.

64. A non-transitory computer readable medium comprising a set of executable instructions to direct a processor to:
provide a predictive model;
capture plant data;
store the plant data;
screen the plant data to determine whether the plant data has a data quality above a threshold;
if the data quality of the plant data is above a threshold, supply the plant data to the predictive model;
determine by the predictive model a predicted yield based on the plant data;
compare the predicted yield to the plant data to determine if a deviation between the plant data and the predicted yield exceeds an acceptable error tolerance; and
send an alert if the deviation exceeds the acceptable error tolerance.

65. The non-transitory computer readable medium of claim 64, wherein the predictive model comprises a non-linear process model.

66. The non-transitory computer readable medium of claim 65, wherein the non-linear process model comprises a plurality of unit representations.

67. The non-transitory computer readable medium of claim 64, wherein capture plant data comprises capture plant data by at least one of a control computer or a data historian.

68. The non-transitory computer readable medium of claim 64, wherein store the plant data comprises store the plant data in a database.

69. The non-transitory computer readable medium of claim 64, wherein the plant data comprises plant inputs and plant outputs.

70. The non-transitory computer readable medium of claim 69, wherein the plant inputs comprise at least one of feed properties or operating conditions.

71. The non-transitory computer readable medium of claim 69, wherein the plant outputs comprise at least one of unit yields or qualities.

72. The non-transitory computer readable medium of claim 64, wherein screen the plant data comprises reconciling the plant data based on a separate process model.

73. The non-transitory computer readable medium of claim 64, wherein data quality above a threshold comprises one of data within a 95% confidence limit or data within twice the standard deviation from the average.

74. The non-transitory computer readable medium of claim 69, wherein supply the plant data to the predictive model comprises supply the plant inputs to the predictive model.

75. The non-transitory computer readable medium of claim 64, wherein the predicted yield comprises at least one of predicted unit yields or predicted qualities.

76. The non-transitory computer readable medium of claim 69, wherein compare the predicted yield to the plant data comprises compare the predicted yield to the plant outputs.

77. The non-transitory computer readable medium of claim 76, wherein the predicted yield comprises at least one of predicted unit yields or predicted qualities, and further wherein the plant outputs comprise at least one of unit yields or qualities.

78. The non-transitory computer readable medium of claim 64, wherein compare the predicted yield to the plant data comprises compare the predicted yield to the plant data to determine a deviation from one of Design-of-Experiment (DOE) validity ranges, predictive model base vector, reference model base case, or average plant data.

79. The non-transitory computer readable medium of claim 64, wherein the acceptable error tolerance comprises one of a 95% confidence limit or twice the standard deviation from the average.

80. The non-transitory computer readable medium of claim 64, wherein compare the predicted yield to the plant data further comprises determine a suggested adjustment to the predictive model and a level of economic significance of the suggested adjustment.

81. The non-transitory computer readable medium of claim 80, wherein determine the suggested adjustment to the predictive model comprises determine the suggested adjustment to the predictive model and the level of economic significance of the suggested adjustment based on a model sensitivity analysis.

82. The non-transitory computer readable medium of claim 81, wherein the model sensitivity analysis comprises at least one of a model sensitivity matrix or a Monte Carlo analysis.

83. The non-transitory computer readable medium of claim 80, wherein the alert comprises the suggested adjustment to the predictive model and the level of economic significance of the suggested adjustment.

84. The non-transitory computer readable medium of claim 83, wherein the suggested adjustment to the predictive model and the level of economic significance of the suggested adjustment are based on a model sensitivity analysis.

85. The non-transitory computer readable medium of claim 84, wherein the model sensitivity analysis comprises at least one of a model sensitivity matrix or a Monte Carlo analysis.

86. The non-transitory computer readable medium of claim 64, further comprising a set of executable instructions to direct a processor to:
in response to the alert, receive an instruction whether to update the predictive model.

87. The non-transitory computer readable medium of claim 86, further comprising a set of executable instructions to direct a processor to:
if the instruction is to update the predictive model, adjust the predictive model to reduce the deviation.
